(19) United States
(12) Patent Application Publication
(10) Pub. No.: US 2009/0274829 A1
(43) Pub. Date: Nov. 5, 2009

(54) Method of Resisting Dust and Dirt with Nanotechnology

(75) Inventor: Chih-Hao Huang, Taipei Hsien (TW)

Correspondence Address: WPAT, PC;INTELLECTUAL PROPERTY ATTORNEYS, 2030 MAIN STREET, SUITE 1300, IRVINE, CA, 92614, US

(73) Assignee: CHENG UEI PRECISION INDUSTRY CO., LTD., Taipei Hsien (TW)

(21) Appl. No.: 12/114,789

(22) Filed: May 4, 2008

(51) Int. Cl. B05D 5/08

(52) U.S. Cl. 427/58

(57) ABSTRACT

A method of resisting dust and dirt with nanotechnology applied to electronic products is described hereinafter. Firstly, make an initial reactant into a metal oxide gel of nanometer by way of a sol-gel method. Secondly, dilute the metal oxide gel of nanometer with a diluent to form a coating solution, and then stand the coating solution for a period of time to make the metal oxide gel of nanometer and the diluent well mixed each other. Next, coat the coating solution onto surfaces of the electronic products evenly. Lastly, put the electronic products coated with the coating solution under a room temperature to make the coating solution evaporated so as to form protective films on the surfaces of the electronic products.

### BACKGROUND OF THE INVENTION

1. Field of the Invention

The present invention generally relates to a method of resisting dust and dirt with nanotechnology, and more particularly to a method of resisting dust and dirt with nanotechnology applied to electronic products.

2. The Related Art

With the development of electronic technology, various kinds of electronic products have been used in our daily life and the living extensively. However, with the increase in service time of the electronic products, a great deal of dust and dirt are apt to be adhered to surfaces of the electronic products to result in aesthetic problems thereof. According to a microcosmic viewpoint, the reason why the dust and the dirt are apt to be adhered to the electronic products is mainly that the surfaces of the electronic products have a lot of tiny holes and some dust and dirt particles are smaller than the tiny holes. Therefore, if the electronic products want to well resist dust and dirt so as to keep the aesthetic thereof, the tiny holes on the surfaces of the electronic products must be filled up effectively. Thus, a method of resisting dust and dirt with nanotechnology applied to the electronic products is required.

### SUMMARY OF THE INVENTION

An object of the present invention is to provide a method of resisting dust and dirt with nanotechnology, which is applied to electronic products mainly and can make the electronic products become resistive to dust and dirt well.

The method of resisting dust and dirt with nanotechnology applied to the electronic products is described hereinafter. Firstly, make an initial reactant into a metal oxide gel of nanometer by way of a sol-gel method. Secondly, dilute the metal oxide gel of nanometer with a diluent to form a coating solution, and then stand the coating solution for a period of time to make the metal oxide gel of nanometer and the diluent well mixed each other. Next, coat the coating solution onto surfaces of the electronic products evenly. Lastly, put the electronic products coated with the coating solution under a room temperature to make the coating solution evaporated so as to form protective films on the surfaces of the electronic products.

As described above, the method of resisting dust and dirt with nanotechnology can effectively fill up tiny holes on the surfaces of the electronic products and form the protective films thereon. Therefore, the electronic products processed by the method of resisting dust and dirt with nanotechnology can well resist dust and dirt.

### DETAILED DESCRIPTION OF THE PREFERRED EMBODIMENT

A method of resisting dust and dirt with nanotechnology according to the present invention is mainly applied to electronic products and is described hereinafter.

Firstly, make a proper initial reactant into a metal oxide gel of nanometer by way of a sol-gel method, wherein the initial reactant can be any of all kinds of metal alkane oxides.

Secondly, dilute the metal oxide gel of nanometer with an alcohol solvent to form a coating solution, wherein the weight percentage of the metal oxide gel of nanometer in the coating solution is 30%. Then stand the coating solution for 24 hours to make the metal oxide gel of nanometer and the alcohol solvent well mixed each other.

Next, coat the coating solution onto surfaces of the electronic products evenly by way of spraying, soaking or wiping so as to effectively fill up tiny holes on the surfaces of the electronic products.

Lastly, put the electronic products coated with the coating solution under a room temperature to make the coating solution dry (namely, evaporated to be a gas phase) naturally so as to form protective films on the surfaces of the electronic products for resisting dust and dirt.

The principle of the above-mentioned method of resisting dust and dirt with nanotechnology is similar to a lotus effect. The lotus effect is that mud and water can only roll on a lotus leaf but can't be adhered to the lotus leaf, because the structure of the lotus leaf is a nanometer structure. According to the lotus effect, the electronic products processed by the method of resisting dust and dirt with nanotechnology can effectively fill up the tiny holes on the surfaces of the electronic products and form the protective films thereon so as to attain an above-mentioned result to make the electronic products become resistive to dust and dirt well.

An unlimited embodiment is described as following. In the unlimited embodiment, the electronic product is a white mouse and the initial reactant is a silane oxide. The silane oxide is made into a silica gel of nanometer by way of the sol-gel method. Dilute the silica gel of nanometer with an ethanol solvent to form a coating solution and stand the coating solution for 24 hours to make the silica gel of nanometer and the ethanol solvent well mixed each other, wherein the weight percentage of the silica gel of nanometer in the coating solution is 30%. Coat the coating solution onto a left key of the mouse evenly, and then put the mouse under the room temperature to make the coating solution evaporated naturally so as to form a protective film on the left key. Next, alternately wipe the left key and a right key of the mouse with a cloth covered with a great deal of dust and dirt for 20 times. At last, observe the mouse, the left key coated with the coating solution almost has no dust and dirt, but the right key is stained with a great deal of dust and dirt. Therefore, it is known from the above-mentioned unlimited embodiment that the mouse processed by the method of resisting dust and dirt with nanotechnology can really resist dust and dirt well.

As described above, the method of resisting dust and dirt with nanotechnology can effectively fill up the tiny holes on the surfaces of the electronic products and form the protective films thereon. Therefore, the electronic products processed by the method of resisting dust and dirt with nanotechnology can well resist dust and dirt.

What is claimed is:

1. A method of resisting dust and dirt with nanotechnology applied to electronic products, comprising the steps of:
firstly, making an initial reactant into a metal oxide gel of nanometer by way of a sol-gel method;
secondly, diluting the metal oxide gel of nanometer with a diluent to form a coating solution, and then standing the coating solution for a period of time to make the metal oxide gel of nanometer and the diluent well mixed each other;
next, coating the coating solution onto surfaces of the electronic products evenly; and
lastly, putting the electronic products coated with the coating solution under a room temperature to make the coating solution evaporated so as to form protective films on the surfaces of the electronic products.

2. The method of resisting dust and dirt with nanotechnology as claimed in claim 1, wherein the initial reactant is any of metal alkane oxides.

3. The method of resisting dust and dirt with nanotechnology as claimed in claim 1, wherein the diluent is an alcohol solvent.

4. The method of resisting dust and dirt with nanotechnology as claimed in claim 3, wherein the weight percentage of the metal oxide gel of nanometer in the coating solution is 30%.

5. The method of resisting dust and dirt with nanotechnology as claimed in claim 4, wherein the coating solution is stood for 24 hours.

6. The method of resisting dust and dirt with nanotechnology as claimed in claim 1, wherein the coating solution is coated onto the surfaces of the electronic products by way of spraying, soaking or wiping.
